(19) United States
(12) Patent Application Publication
(10) Pub. No.: US 2025/0129895 A1
(43) Pub. Date: Apr. 24, 2025

(54) FLUID CONTAINER PROVIDED WITH A DISPENSING VALVE WITH AN ELECTRONIC DEVICE RETAINED BY A PROTECTIVE COVER

(71) Applicant: L'Air Liquide, Societe Anonyme pour l'Etude et l’Exploitation des Procedes Georges Claude, Paris (FR)

(72) Inventors: Jean-Baptiste LOBEZ, Paris (FR); Philippe RUDNIANYN, Antony Cedex (FR)

(21) Appl. No.: 18/920,457

(22) Filed: Oct. 18, 2024

(30) Foreign Application Priority Data
Oct. 19, 2023 (FR) 2311289

(51) Int. Cl. F17C 13/04

(52) U.S. Cl. CPC F17C 13/04; F17C 2201/0104; F17C 2203/0636; F17C 2203/0658; F17C 2205/0308; F17C 2205/0326; F17C 2205/0394; F17C 2221/011; F17C 2221/03; F17C 2221/031; F17C 2250/032

(57) ABSTRACT

The invention relates to a pressurised fluid container (30), in particular a gas cylinder, having a container body (31) fitted with a fluid dispensing valve (10) and also an electronic device (20) having a casing (21) having an end fitting (25) configured to be housed in an end fitting housing (15) of the valve body (10). A protective cover (40) is arranged around the valve body (11). The peripheral wall (21.1) of the casing (21) is shaped for the peripheral edge (43) of the opening (42) of the cover (40) in order to keep the electronic device (20) secured to the cover (40) when its end fitting (25) is housed in the end fitting housing (15) of the valve body (11).

### CROSS-REFERENCE TO RELATED APPLICATIONS

This application claims the benefit of priority under 35 U.S.C. § 119 (a) and (b) to French patent application No. 2311289, filed Oct. 19, 2023, the entire contents of which are incorporated herein by reference.

### BACKGROUND

The invention relates to a pressurised fluid container, preferably a gas container, in particular a pressurised gas cylinder, fitted with a fluid dispensing valve fitted with an electronic device that is not fastened to the fluid dispensing valve.

### FIELD OF THE INVENTION

Medical fluids or gases, such as oxygen, NO/N₂, N₂O/O₂, He/O₂ mixtures, medical air or the like, are packaged in pressurised gas containers, in particular gas cylinders or canisters, which are fitted with a dispensing tap, which is also referred to as a valve, with or without an integrated pressure regulation system (IPR), that is used to provide an adjustable gas flow rate.

### RELATED ART

The dispensing valve can be fitted with an electronic device with a digital display for displaying, in particular during gas withdrawal, the residual gas pressure in the container or the gas autonomy, i.e., the operating duration before the container is (almost) empty, as taught in EP-A-2918892, EP-A-3421866, US-A-2015/048955, US-A-6085598, EP-A-3067665 or DE-A-3809142.

In order to protect the dispensing valve and its fragile equipment from impacts, droppages, dirt, etc., in particular the electronic device with a digital display, a rigid protective cover, which is also referred to as a “cap”, is normally arranged around the dispensing valve fitted to the gas cylinder.

### SUMMARY OF THE INVENTION

The electronic device generally comprises a casing containing one or more (micro) processors supported by an electronic board and a display screen for computing and/or displaying one or more parameters useful to the user, such as the gas flow rate, the gas pressure, the autonomy, the gas volume or any other parameter. Pressure measurement means are also provided, in particular a pressure sensor or a combined pressure and temperature sensor, which are connected to the electronic board, in particular to the (micro) processor, in order to send it the pressure measurements that are computationally processed therein.

In order to be able carry out the pressure measurements, the pressure sensor of the electronic device is fluidly connected to the internal gas circuit of the valve, which is fluidly connected to the internal volume of the container and which conveys the gas requiring pressure and temperature measurements, typically via an internal channel or “branch” passing through the connection end fitting that is used to fasten the electronic device to the valve, as described in EP-A-3421866.

In other words, the electronic device is generally securely fastened to the valve body by screwing its threaded end fitting into a tapped recess of the valve body, or using a key or pin inserted into a housing provided in the valve body and in the side wall of the end fitting of the electronic device, or using any other fastening system for securing these elements together, by retaining the electronic device firmly in position on the valve despite the pressure stresses it experiences, given that its end fitting experiences the high pressure conveyed by the internal gas circuit of the valve. Examples of the fastening of such valves are provided in EP 3421866 and EP 3377811.

Once the electronic device is fastened to the valve body via the end fitting of the casing, the protective cover is arranged around the valve and the casing of the electronic device is positioned in an opening provided in the cover so that it can be seen from the outside, i.e., so that the user can read the information it provides on its display screen. Examples of valves with such electronic devices housed in an opening of their cover include EP 3002498, EP 4027051, EP 4056962, EP 4071399, EP 4071400, FR 3018580 and WO 2023/156960.

However, in practice it has been found that fastening the electronic device to the valve body by screwing its threaded end fitting into a tapped recess of the valve body, or using a key or a pin inserted into a housing provided in the valve body and in the side wall of the end fitting of the electronic device, or the like, has its disadvantages.

Firstly, these types of fastener require additional machining of the valve body and of the end fitting of the electronic device, for example, tapping the housing and threading the end fitting, or even require additional perforation of the valve body and of the end fitting in order to accommodate a key or a pin, or the like.

Secondly, disassembling the electronic device from the valve body, notably for maintenance or replacement operations, can be complicated.

In view of this, a problem therefore involves being able to simply install an electronic device and a protective cover on the body of a fluid dispensing valve, without using any additional machining of the end fitting of the electronic device and/or of the housing accommodating it in the valve body, while ensuring correct positioning of the cover/electronic device assembly on the valve body, and allowing easy disassembly thereof, notably during maintenance or replacement operations, i.e., in order to overcome the aforementioned disadvantages.

### DETAILED DESCRIPTION OF THE PREFERRED EMBODIMENTS

A solution according to the invention then relates to a pressurised fluid container, in particular a pressurised gas cylinder or canister, comprising a container body having an internal volume for conserving, i.e., storing, a pressurised fluid, typically a gas or a gaseous mixture, and fitted with a fluid dispensing valve comprising:
a valve body comprising an end fitting housing opening outwards;
an electronic device comprising a casing comprising an end fitting configured to be housed in the end fitting housing of the valve body; and
a protective cover arranged around the valve body, comprising an opening, i.e., a window or the like, comprising a peripheral edge surrounding the casing of the electronic device.

Furthermore, at least part of the peripheral wall of the casing of the electronic device is shaped so as to cooperate with at least part of the peripheral edge of the opening of the protective cover in order to keep the electronic device secured to the protective cover, when the end fitting of the casing is housed in the end fitting housing of the valve body.

In addition, the peripheral wall of the casing of the electronic device and the peripheral edge of the opening of the protective cover are shaped so as to have matching shapes enabling the electronic device to be secured to the protective cover, i.e., the peripheral edge of the opening of the cover conforms to the peripheral wall of the casing of the electronic device, i.e., its peripheral contour.

In particular, the peripheral wall of the casing of the electronic device comprises at least one peripheral groove and the peripheral edge of the opening of the protective cover comprises at least one shoulder, or vice versa, i.e., according to another embodiment, the peripheral wall of the casing of the electronic device comprises at least one shoulder and the peripheral edge of the opening of the protective cover comprises at least one peripheral groove.

However, in all cases, said at least one shoulder is then inserted into said peripheral groove in order to secure the electronic device to the protective cover, i.e., to retain it in on the cover and on the valve body.

In other words, according to the invention, it is the peripheral edge of the opening of the cover, or at least part of it, that retains the electronic device in position on the valve body, or vice versa, and not a threading/tapping, key or pin or the like.

According to the considered embodiment, the pressurised fluid container of the invention can comprise one or more of the following features:
the end fitting housing arranged in the valve body has a closed base;
the end fitting of the casing is retained in position in the end fitting housing of the valve body by the protective cover when it cooperates with the casing of the electronic device;
the valve body comprises an internal fluid circuit for conveying pressurised fluid from the internal volume of the container body;
said at least one peripheral groove is arranged on at least part of the outer perimeter of the peripheral wall of the casing of the electronic device;
said at least one peripheral groove is formed in the outer wall of the casing of the electronic device, i.e., by recessing the outer wall of the casing;
said at least one peripheral groove forms a channel;
alternatively, the groove is delimited by two small parallel walls arranged opposite one another and supported by the outer wall of the casing of the electronic device, i.e., projecting from said outer wall of the casing;
said at least one peripheral groove is formed over only part or over the entire periphery of the casing;
according to a particular embodiment, the peripheral wall of the casing of the electronic device comprises several peripheral grooves and the peripheral edge of the opening of the protective cover comprises several shoulders, or vice versa, that cooperate so as to secure the casing of the electronic device to the protective cover, in particular the shoulders are then inserted into the peripheral grooves in order to ensure that the electronic device is secured to the protective cover, i.e., to ensure that it is retained on the cover;
according to another particular embodiment, the peripheral wall of the casing of the electronic device comprises at least one peripheral groove and at least one shoulder, and the peripheral edge of the opening of the protective cover also comprises at least one peripheral groove and at least one shoulder, with said peripheral grooves and shoulders being arranged and configured so that each groove is inserted into a shoulder and vice versa, so that each shoulder accommodates a groove, so as to secure the electronic device to the protective cover, i.e., to ensure that it is retained on the cover;
the one or more peripheral grooves and the one or more shoulders assume shapes that are at least partially matching so as to allow them to cooperate by interlocking or the like;
said at least one shoulder is arranged on at least part, i.e., all or part, of the inner perimeter of the peripheral edge of the opening of the protective cover;
the end fitting of the casing assumes a first generally cylindrical shape and is devoid of external threading;
the length of the end fitting of the casing ranges, for example, between 5 and 11 mm, preferably between 6 and 8 mm, and its diameter ranges between 5 and 12 mm, preferably between 7 and 9 mm;
the end fitting housing of the valve body assumes a second generally cylindrical shape and is devoid of an internal tapping;
the first generally cylindrical shape of the end fitting of the casing and the second generally cylindrical shape of the end fitting housing of the valve body match each other, i.e., the outer wall of the end fitting of the casing conforms to the inner wall of the end fitting housing of the valve body;
the peripheral wall of the casing of the electronic device has a square or rectangular outer periphery, i.e., the casing is a rectangular or square parallelepiped;
the opening of the protective cover has a square or rectangular inner periphery;
the outer periphery of the casing matches the inner periphery of the opening of the cover, i.e., the outer periphery of the casing conforms to the inner periphery of the opening of the cover;
the electronic device is secured to the valve body, and the end fitting of the casing is kept housed in the end fitting housing of the valve body, solely by virtue of the cooperation between at least part of the peripheral wall of the casing of the electronic device and at least part of the peripheral edge of the opening of the protective cover, i.e., no threading/tapping, no pin or key or the like are required;
the end fitting of the casing also forms a centring stud allowing the casing to be correctly positioned on the valve body;
the end fitting is made of polymer, for example, of thermoplastic polymer (TPE) material;
the housing is retained on the valve body, therefore, the retention of the end fitting of the casing within the end fitting housing of the valve body is solely provided by the protective cover, which, via the edge of the housing accommodating the casing, constrains the casing in order to securely retain it in position;
the casing is rigid;
the casing is made of metal or polymer;
the protective cover comprises a rigid cover body;
the cover body defines an internal volume that is designed to accommodate the gas dispensing valve;
the cover body is made up of (at least) 2 half-shells joined together, typically a right-hand half-shell and a left-hand half-shell;
the 2 half-shells are substantially symmetrical to each other;
the 2 half-shells are connected to each other along a junction plane separating the opening of the cover into two substantially equal parts, i.e., a junction plane passing through the centre of the opening;
the cover body is made of a polymer material, of metal or of combinations thereof;
the electronic device comprises (micro) processor-based data processing means, i.e., comprising one or more (micro) processors;
the data processing means comprise at least one microprocessor arranged on an electronic board;
it comprises pressure measurement means configured to measure (at least) the pressure of the fluid inside the internal fluid circuit;
the data processing means are configured to process the one or more pressure measurements performed by the pressure measurement means;
the pressure measurement means are arranged in the valve body so as to be separate from the electronic device, while only being electrically connected to the electronic device by electrical connection means;
the pressure measurement means comprise a pressure sensor connected to the internal gas circuit in order to perform the one or more pressure measurements, preferably a combined pressure and temperature sensor configured to perform fluid pressure and temperature measurements;
the electrical connection means comprise wired electrical connections, such as wires or cables;
the electrical connection means comprise an electrical ribbon;
the ribbon comprises at least 4 electrical wires, typically from 4 to 20 electrical wires arranged parallel to one another;
the pressure measurement means are arranged in a sensor housing provided in the valve body;
the sensor housing provided in the valve body comprises a base;
the sensor housing provided in the valve body is open to the outside;
the sensor housing is fluidly connected to the internal fluid circuit of the valve body, preferably via a measurement port provided in the base of the sensor housing;
the pressure measurement means comprise additional data processing means, such as an additional electronic board, for computationally processing the measurements performed by the pressure sensor and for obtaining processed measurements;
the additional data processing means comprise one or more microprocessors;
the electrical connection means, in particular the electrical ribbon, connect the additional data processing means to the data processing means of the electronic device so as to supply them with the processed measurements originating from the additional data processing means;
the data processing means are configured to determine a residual gas pressure or gas autonomy by processing the pressure or pressure and temperature measurements supplied by the pressure measurement means;
the internal gas circuit is arranged in the valve body and extends between a fluid inlet orifice fluidly connected to the internal volume of the container body and at least one fluid outlet orifice supported by a fluid dispensing end fitting;
the fluid inlet orifice is supported by the threaded end fitting fastener of the valve that is typically conical shaped;
the electrical ribbon is flexible, i.e., soft and deformable, so as to facilitate connections and its installation;
the pressure sensor, and optionally the temperature sensor, is electrically connected to the additional data processing means in order to provide said additional data processing means with measurements (i.e., signals) of the pressure and the temperature of the fluid;
the pressure and temperature sensor is configured to measure temperatures ranging between −40° C. and +70° C. and pressures ranging between 0 and at least 150 bar abs, preferably at least 250 bar abs;
the pressure and temperature sensor comprises a sensor body, through which an internal passage passes allowing the pressure and the temperature to be measured, i.e., forming a single branch for taking the pressure and the temperature;
the data processing means of the electronic device, in particular the one or more microprocessors, are configured to process the one or more pressure and temperature measurements;
the one or more microprocessors implement one or more algorithms;
the data processing means of the electronic device comprise at least one microcontroller. More specifically, one or more microprocessors can be integrated in the electronic device in the form of a microcontroller;
the one or more microprocessors, in particular the one or more microcontrollers, is/are configured to store data, notably within software or a dedicated algorithm;
the single pressure and temperature sensor is fluidly connected to the internal gas circuit of the fluid dispensing valve so as to allow pressure and temperature measurements to be performed on the gas conveyed by said internal circuit, i.e., within the internal gas passage of the gas dispensing valve;
the data processing means, in particular the one or more microprocessors, are supplied with electric current by an electric current source;
the pressure and temperature sensor, in particular the additional data processing means of said sensor, is supplied with electric current by an electric current source;
the pressure and temperature sensor comprises additional data processing means or on-board electronics for determining the pressure and the temperature of the gas;
the additional data processing means cooperate with membrane-based means for determining the pressure of the gas and temperature sensor means for measuring the temperature of the gas;
the membrane-based means and the temperature sensor means are arranged so as to be in contact with the gas conveyed via the internal passage in the sensor body, i.e., one and the same gas duct;
the additional data processing means, i.e., the on-board electronics of the pressure and temperature sensor, are electrically connected to the data processing means of the electronic device in order to send them signals and/or measured pressure and temperature values, in particular via the ribbon;
the on-board electronics of the pressure and temperature sensor comprise one (or more) additional microprocessors;
the electronic device is a digital manometer configured to provide the gas pressure or the gas volume in the container and the gas flow rate provided by the valve and/or the autonomy, i.e., the operating duration relative to the amount of residual fluid in the container and/or to the gas flow rate supplied by the valve;
the electric current source comprises one or more electric batteries or cells, which may or may not be rechargeable;
the electronic device comprises a digital display, i.e., such as an information display screen, for example, of the LCD type;
the electronic device comprises a digital display placed in the opening of the cover so that it can be viewed by a user from outside;
the screen is substantially continuous with the surface of the cover body;
the fluid dispensing valve comprises a flow rate selection device for selecting a desired fluid flow rate, preferably ranging between 0 and 30 L/min;
the fluid dispensing valve comprises a flow rate outlet connector for providing the fluid, typically a gas, at the desired flow rate;
the fluid dispensing valve comprises a pressure outlet connector for providing the fluid, typically a gas, at a given pressure;
the outlet connector comprises means for controlling the output of gas;
the fluid dispensing valve comprises a fluid inlet orifice fluidly connected to the internal gas circuit of the fluid dispensing valve so as to allow pressurised fluid to enter the internal gas circuit of the fluid dispensing valve;
the fluid inlet port of the fluid dispensing valve is fluidly connected to the internal volume of the fluid container;
the internal gas circuit of the fluid dispensing valve fluidly connects the fluid inlet orifice to the outlet connector in terms of flow rate or pressure;
the internal gas circuit of the fluid dispensing valve is arranged, for example, perforated, in the body of the fluid dispensing valve;
the flow rate or pressure outlet connector of the fluid dispensing valve is configured to be fluidly connected to a flexible gas duct or to another device using the fluid, such as a medical device or apparatus;
the flow rate selection device comprises a rotary handwheel configured to move between several positions that are angularly offset from one another, with each position corresponding to a given desired gas flow rate value;
the flow rate selection device allows desired gas flow rates to be selected ranging between 0 and 30 L/min, typically between 0 and 25 L/min;
the flow rate selection device also cooperates with a flow rate adjustment device arranged in the body of the valve in order to adjust the flow rate to the desired gas flow rate value;
the flow rate adjustment device comprises a calibrated orifice disc arranged in the gas path in the valve body;
the gas outlet (flow) connector is arranged in the centre of the rotary handwheel, i.e., they are arranged coaxial to each other;
the data processing means comprise a time counter;
the container has an internal volume ranging between 1 and 20 L, typically between 2 and 15 L (water equivalent);
the digital display of the electronic device is configured to display information, in particular gas autonomy, gas pressure, gas volume or a warning icon, for example, an autonomy warning or a hose clamping warning, or other warnings;
the data processing means are configured to trigger an audible warning and a visual warning if a warning is triggered, in particular a clamping warning or an autonomy warning;
it further comprises data storage means;
the data storage means comprise a read-only memory, preferably an EEPROM or the like;
the data storage means are arranged on an electronic board, preferably on the electronic board supporting the microprocessor;
the electrical power source electrically powers the data processing means, typically the electronic board, the one or more microprocessors, and all the components operating with electric current, such as the digital display, the pressure and temperature sensor and/or a warning LED;
the electric current source is arranged in a compartment of the protective cover;
the cover body comprises one or more carrying handles, preferably the carrying handle is arranged so as to surmount the cover, i.e., it is located substantially on top of the cover;
the gas dispensing valve is a valve with an integrated pressure regulator or IPR;
gas pressure regulation means are arranged on the internal gas circuit;
the gas pressure regulation means comprise a pressure-regulating valve and a valve seat. They allow the pressure of the gas to be reduced from the high pressure of the gas stored in the container, typically bar ranging from several tens to hundreds, down to a lower, preset operating pressure, typically a few bar, for example, from 2 to 5 bar abs;
the valve body is made of copper alloy, such as brass;
the cover body further comprises an attachment system designed to allow it to be attached to a support, in particular to a hospital bed rail or to a patient transport stretcher or the like;
the cover body further comprises a movable, preferably pivoting, attachment system;
the fluid container is a pressurized gas cylinder;
the fluid container contains a pressurised gas, in particular a medical gas;
the fluid container, when full, contains a gas at a pressure of at least 130 to 200 bar abs, or even of at least 300 bar abs;
the fluid container has a cylindrical, in particular ogival, general shape, made of metal or metal alloy (for example, steel, aluminium, etc.) or of one or more composite materials;
the fluid container contains a gas or a gaseous mixture, such as oxygen, an NO/N₂, O₂/N₂O or He/O₂ mixture, medical-grade air, or the like.

The invention also relates to the use of a container according to the invention for storing or supplying a pressurized gas, in particular a medical gas selected from among oxygen or a gaseous mixture of N₂O/O₂, NO/N₂, He/O₂, medical air or another medical gas.

### BRIEF DESCRIPTION OF THE FIGURES

The invention will now be better understood from the following detailed description, which is provided by way of a non-limiting illustration, with reference to the appended figures, in which:

FIG. 1 shows an embodiment of a fluid container fitted with a fluid dispensing valve with an electronic device retained by a protective cover according to the invention;

FIG. 2 shows an embodiment of the fluid dispensing valve of FIG. 1, shown bare, i.e., without any equipment;

FIG. 3 is a diagram (partial cross-sectional view) of an embodiment showing the cooperation between the cover and the casing of the electronic device according to the invention; and

FIG. 4 is a diagram (side view) of the fluid dispensing valve of FIG. 1 and FIG. 2 fitted with the electronic device and other equipment.

### DETAILED DESCRIPTION OF THE INVENTION

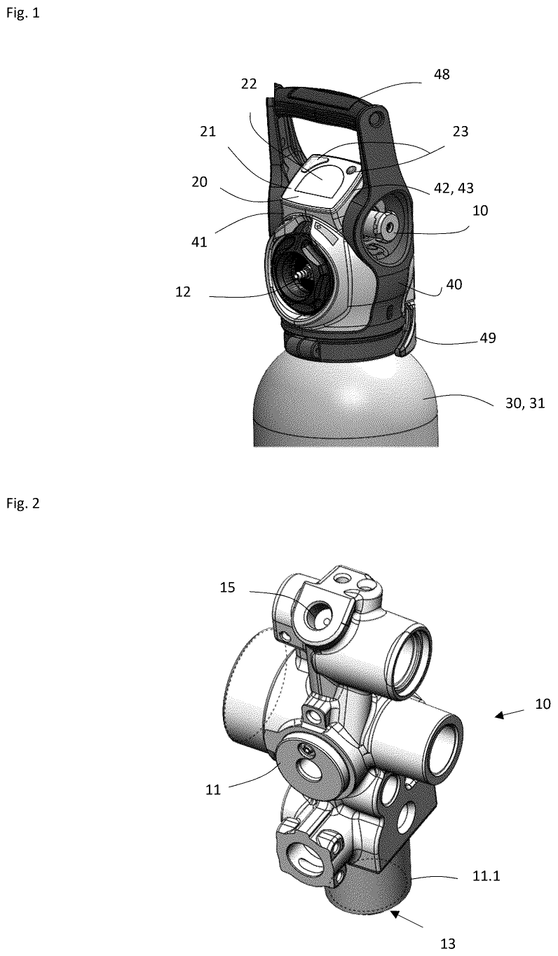

FIG. 1 shows an embodiment of a fluid container 30, in this case a pressurised gas cylinder, such as an oxygen cylinder, fitted with a fluid dispensing valve 10 with an electronic device 20 retained by a protective cover 40 according to the invention.

The pressurised gas cylinder (partially shown) conventionally comprises a cylindrical body 31 delimiting an internal volume receiving the pressurised fluid, typically a pressurised gas, such as medical oxygen, at a pressure (i.e., filled container) of more than 100 bar abs, typically at least 150 bar abs, or even more than 200 bar abs, for example, a maximum pressure ranging from 130 to 300 bar abs. The container body 31 is generally made of metal or a metal alloy, such as steel or an aluminium alloy, or of composite materials.

The container 30 supports a fluid dispensing valve 10, preferably an IPR, i.e., a valve with an integrated pressure reducer, through which an internal fluid circuit passes that is fluidly connected to the internal volume of the container.

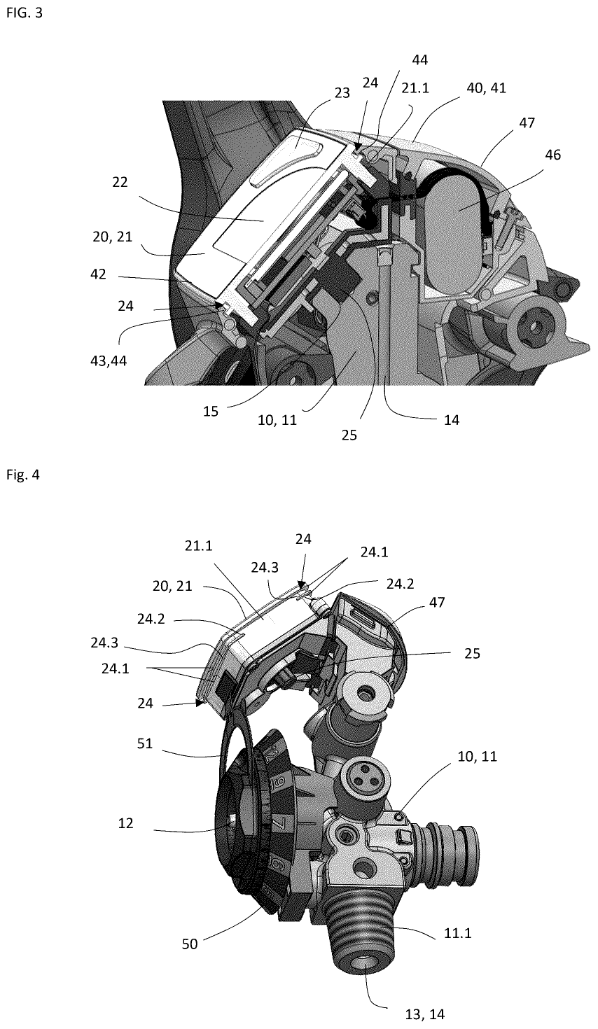

The valve body 11, which is more clearly shown in FIG. 2, is preferably made of brass or stainless steel. The internal fluid circuit 14, which is partially visible in FIG. 3 and which comprises one or more passages for the gas provided in the valve body 11, for example, perforated or machined passages, connects and extends between an inlet orifice 13 fluidly connected to the internal volume of the container body 31 and one (or more) fluid outlet orifices supported by one (or more) fluid dispensing end fittings 12, such as a flow rate outlet connector.

The fluid inlet orifice 13 is supported by the threaded fastening end fitting 11.1 of the valve body 11, typically a tapered threaded end fitting 11.1.

The fluid circuit 14 conveys the fluid, namely, gas in this case, originating from the container 30 through the valve body 11 for dispensing gas to the fluid dispensing end fitting 12, to which a flexible gas duct (not shown) is normally fluidly connected for conveying the gas to another device (not shown) using the gas, i.e., a medical appliance or device using the gas supplied by the valve 10, for example, a breathing mask dispensing gas to a patient at a flow rate prescribed by a doctor or the like corresponding to a treatment to be followed.

The container body 31 has a generally cylindrical shape comprising a neck, at its upper end, to which the valve 10 is fastened, i.e., it is ogive-shaped. The neck comprises the fluid outlet orifice, which is typically tapped, communicating with the internal volume of the container 30 and allowing gas to be withdrawn from the internal volume or, conversely, allowing it to be filled when it is empty. The dispensing valve 10 is mounted, typically screwed, in the vicinity of the orifice in the neck of the container 30, via the threaded fastening end fitting 11.1 of the valve body 11, which comprises a thread matching a tapping provided in the orifice in the neck of the container 30.

The fluid stored in the container 30, i.e., in its internal volume, is typically a gas or a gaseous mixture, for example, of medical-grade or a medical gas, such as oxygen, air, a mixture of NO/N₂, Ar/O₂, O₂/N₂O or He/O₂, or any other gas or gaseous mixture, preferably oxygen or an O₂/N₂O gaseous mixture.

The gas dispensing valve 10 comprises pressure measurement means for measuring (at least) the pressure of the gas within the internal circuit 14 of the valve body 11. They typically comprise a pressure sensor with a pressure tap, i.e., a branch, fluidly connected to the internal circuit of the valve body 11. Advantageously, a combined pressure and temperature sensor is used to measure both the pressure and the temperature of the gas within the internal gas circuit conveying the gas originating from the internal volume of the container 30.

The pressure and preferably the temperature measurement means are configured to supply the pressure and preferably the temperature measurements (i.e., measurement signals or values) to microprocessor-based data processing means comprising one or more microprocessors implementing one or more algorithms, for example, a main electronic board supporting one (or more) microprocessors implementing one or more computation or analogue algorithms, preferably a microcontroller.

More specifically, the pressure measurements or data, and optionally the temperature measurements, performed by the sensor are processed by on-board electronics within the sensor, for example, a secondary electronic board with one or more microprocessors or the like.

These measurements (i.e., signals or values) or data are then sent to microprocessor-based data processing means in order to be used in said means, i.e., computationally processed, notably in order to determine, compute or deduce a pressure or a gas autonomy therefrom. A time counter inside the data processing means also can be provided.

The data processing means are arranged in the casing 21 of the electronic device 20, for example, a digital manometer, fastened to the body 11 of the fluid dispensing valve 10, for example, a rigid casing 21 made of polymer or metal. The casing 21 of the electronic device 20 in this case assumes a generally rectangular parallelepiped shape.

One or more buttons 23 or selection keys, which can be activated by digital pressure from the user in order to make selections, also can be provided on the casing 21 in order to scroll through one or more menus, to acknowledge a warning or the like.

The electronic device also comprises display means 22, such as a digital display or screen, for example, an LCD screen or the like, used to display various items of information, such as the volume or the pressure of the gas in the container 1 or even the gas autonomy (in hours and minutes, for example), which are notably obtained by processing pressure and/or temperature measurements using the data processing means, or even to display a warning message. For example, the digital display 22 comprises a screen ranging between approximately 29 and 37 mm high and, for example, ranging between approximately 39 and 43 mm wide.

The casing 21 comprises an end fitting 24 on its lower face, i.e., the face opposite the upper face supporting the screen 22. This end fitting 24 is housed in an end fitting housing 15 in the valve body 11, which is shaped and designed to accommodate the end fitting 24, as described below. Preferably, the end fitting housing 15 has a closed base.

The internal volume of the container 30 (by water equivalent) is a known value that can be stored by storage means, such as an EEPROM-type computer memory, in the electronic device 20. For example, the gas cylinders used to dispense medical oxygen (i.e., medical-grade) have volumes that are between 1 L and 20 L (by water equivalent), typically between 2 L and 15 L, for example, depending on the considered cylinder, the volume can be of the order of 2 L, 3.5 L, 4.6 L, 5 L, 7 L, 10 L, 11 L or 15 L.

The storage means can also store other data, such as, for example, the duration that has elapsed between successive times, the pressure and/or temperature measurements, or other parameters, such as the position of the selector, the configuration of the cylinder, the filling pressure, warnings, etc.

More generally, the electronic device 20, for example, a digital manometer, which comprises the microprocessor-based data processing means, such as an electronic board, is housed in an opening 42, i.e., a window or the like, provided in the body 41 of the protective cover 40 that is arranged around the fluid dispensing valve 10 and that is used to protect it from impacts or other possible damage, for example, a rigid cover made of polymer and/or of metal, as illustrated in FIG. 1. The cover 40 is generally fastened to the neck of the container 30 or to the body 1 of the valve 10.

The body 41 of the cover 40 defines an internal volume designed to house the gas dispensing valve 10. It also comprises, in the proposed embodiment, a carrying handle 48 arranged so as to surmount the cover 40 while being connected to the body 41, in this case using two support posts. Optionally, the cover 40 can further comprise an attachment system 49 (partially visible), preferably a pivoting attachment, designed to allow it to be attached to a support, in particular to a hospital bed rail or to a patient transport stretcher or the like.

The electronic device 20 is electrically powered by an electrical energy source 46, for example, one or more batteries or cells arranged in a battery compartment 47, as illustrated in FIG. 3 and FIG. 4. The electrical energy source is used to power the components requiring electrical current in order to operate, notably the data processing means, the display screen 22, the memory, etc. The electrical energy source 46 is connected to the electronic device 20 by electrical connections, for example, wires or the like.

The data processing means are also configured to control audible warning means and/or visual warning means, preferably both, so as to trigger at least one audible warning and/or one visual warning, preferably both, if a malfunction is detected, in particular a clamping malfunction, or an excessively low amount of gas or autonomy.

As illustrated in FIG. 4, a flow rate selection device 50 that can be activated by a user, such as a rotary handwheel, supported by the valve body 11, is used to select a desired gas flow rate to be provided by the outlet end fitting 12, for example, a rotary handwheel that can rotate between several angular positions, offset from one another, which each correspond to a given flow rate value, for example, selectable gas flow rate values ranging between 0 L/min and 30 L/min, typically between 0 and 25 L/min. For example, the selectable flow rate values can be as follows: 0, 0.5, 1, 2,3, 5, 8, 10, 12, 15, 20, 22 and 25 L/min, or any other value. The desired flow rate value selected by the user by activating the flow rate selection device 50.

The flow rate selection device 50 also cooperates with a flow rate adjustment device (not shown) arranged in the valve body 11 in order to adjust the flow rate to the desired gas flow rate value, for example, the flow rate adjustment device can be a calibrated orifice disc arranged in the path of the gas in the valve body 11. Such an arrangement is known per se.

Once the desired gas flow rate has been selected, the position of the flow rate selection device 50, for example, the angular position of the rotary handwheel, can be determined by means of a position sensor 51 (or several position sensors) visible in FIG. 4, which is electrically connected to the data processing means of the electronic device 20 in order to provide it with position information. This then allows the data processing means to know the value of the desired gas flow rate that has been selected by the user.

In the embodiment of FIG. 4, the flow rate outlet connector 12 is arranged at the centre of and coaxial to the flow rate selection rotary handwheel 50; however, they also could be separate from one another according to other possible embodiments (not shown). The flow rate outlet connector 12 supports an outlet orifice for dispensing gas, i.e., it forms an outlet from the internal passage 14 of the valve body 11.

Preferably, gas outlet control means are also provided, typically an axially movable valve in the connector 12 and cooperating with a valve seat, sealing means, such as one or more O-rings, and a resilient means, such as a spring or the like, normally urging the valve against the seat in order to provide a gas-tight seal when gas is not withdrawn, i.e., dispensed.

According to the invention, in order to be able to quickly and simply couple the electronic device 20 to the body 11 of the fluid dispensing valve 10 without having to machine the end fitting 25 of the electronic device 20 or the end fitting housing 15 of the valve body 11 where it is housed, and then to be able to disassemble them easily, notably during maintenance or replacement operations, i.e., to overcome the aforementioned disadvantages, provision is made for at least part of the peripheral wall 21.1 of the casing 21 of the electronic device 20 to be shaped so as to cooperate with at least part of the peripheral edge 43 of the opening 42, i.e., a window or the like, of the protective cover 40 in order to secure the electronic device 20 to the valve body 11 and the protective cover 40, when the end fitting 25 of the casing 21 is housed, i.e., positioned, in the end fitting housing 15 of the valve body 11, as illustrated in FIG. 3.

The end fitting 25 of the casing 21 of the electronic device 20 therefore merely forms a type of centring stud that is inserted into the end fitting housing 15 of the valve body 11 in order to ensure that the electronic device 20 is correctly positioned on the body 11 of the fluid dispensing valve 10. In other words, according to the invention, the end fitting 25 is no longer involved in actually fastening the casing 21 to the valve body 11 since it is not retained by screwing, pinning or the like, in the end fitting housing 15 of the valve body 11. It is simply inserted therein, i.e., positioned therein.

The casing 21 of the electronic device 20 is retained in place solely by the cover 40, which constrains it as described below.

More specifically, as shown in FIG. 3, the peripheral wall 21.1, i.e., the outer perimeter, of the casing 21 of the electronic device 20 and the peripheral edge 43, i.e., the periphery, of the opening 42 of the protective cover 40 are shaped so as to have matching shapes to ensure that the electronic device 20 is secured to the protective cover 40.

The opening 42 of the cover 40, i.e., a window or the like, has a substantially rectangular or square periphery.

According to the invention, the peripheral edge or the periphery 43 of the opening 42 of the cover, or at least part of it, retains the electronic device 20 in position on the valve body 11, and not a thread/tapping, a key or a pin or the like, as in the valves of the prior art.

The electronic device 20 is secured by at least one peripheral groove 24 supported by the peripheral wall of the casing 21 of the electronic device 20 and by at least one shoulder 44 arranged in the vicinity of the peripheral edge 43 of the opening 42 of the protective cover 1 that cooperate together.

In another embodiment, the one or more peripheral grooves 24 could be arranged in the vicinity of the peripheral edge 43 of the opening 42 of the cover, and the one or more shoulders 44 could be arranged on the periphery of the casing.

In all cases, the shoulder 44 is inserted into the peripheral groove 24 to ensure that the electronic device 20 is secured, i.e., fastened and retained, to the protective cover 40.

The peripheral groove 24 can be continuously arranged around the entire periphery or outer perimeter of the casing 21 of the electronic device 20 or can be discontinuous, as shown in FIG. 4, i.e., around only part of the periphery or outer perimeter of the casing 21 of the electronic device 20.

For example, the groove 24 can be mainly arranged (continuous walls 24.1) on two opposite faces of the casing 21 when it is a rectangular parallelepiped shape (i.e., with an approximately rectangular or square cross-section), and can extend slightly, i.e., over a short distance (i.e., discontinuous wall 24.2), over the other two faces, as illustrated in FIG. 4.

More specifically, according to the invention, the one or more grooves 24 can be formed:
either by removing material so as to form a type of channel, “hollowed out” or “moulded”, for example, in the outer wall of the casing 21;
or, as illustrated in FIG. 4, by two small walls 24.1, 24.2, which are continuous or discontinuous, arranged face to face and projecting from the surface of the periphery of the casing 21, while being separated from each other by an intermediate space or channel 24.3, for example, small walls moulded with the rest of the casing 21 or added and fastened, for example, by gluing or other means. In this case, one of the walls 24.1 is continuous around the entire periphery of the casing 21, whereas the other wall is discontinuous since it only partially extends over two of the opposite faces of the casing 21, via small expansions of the wall 24.2.

However, it should be noted that the casing 21 can assume various shapes, for example, with a circular cross-section or another cross-section. The same applies to the opening 42 of the cover 40, which assumes a shape that matches that of the casing 21 that is inserted therein, i.e., the external contours of the casing 21 conform to the shape of the opening 42 of the cover 40.

In order to facilitate the installation of the assembly, notably the insertion of the shoulder 44 located in the vicinity of the peripheral edge 43 of the opening 42 of the protective cover 1, within the peripheral groove 24 of the casing 21 of the electronic device 20, the protective cover 40 is preferably formed by at least two half-shells, i.e., a right-hand half-shell and a left-hand half-shell, which are coupled together along a junction plane preferably passing through the opening 42, for example, through the centre of the opening 42, as illustrated in FIG. 3, where only the left-hand half-shell is installed so that the casing 21 is positioned in a “half” opening 42.

When the casing 21 of the electronic device 20 is secured to the protective cover 40, by virtue of the cooperation between the shoulder 44 supported by the peripheral edge 43 of the opening 42 of the cover 1 and the peripheral groove 24 of the casing 21 of the electronic device 20, the end fitting 25 of the casing 21 acts as a centring stud to ensure correct positioning of the cover 40/electronic device 20 assembly on the valve 10, when it is installed by an operator, given that the end fitting 25 of the casing 21 is positioned in the end fitting housing 15 machined in the valve body 11, typically a housing or a hole with a closed base. The cover 40 then can be firmly fastened, for example, by screwing or the like, either to the body 11 of the valve 10 or to the neck of the gas container 30.

Preferably, the end fitting 25 of the housing 21 assumes a substantially cylindrical general shape. It has a smooth peripheral wall, i.e., devoid of an external thread or other fastening means. Similarly, the end fitting housing 15 of the valve body 11 also has a substantially cylindrical overall shape and a smooth internal wall, i.e., devoid of internal tapping. Advantageously, their shapes substantially match each other, i.e., they are designed to ensure stable, i.e., non-floating, retention of the end fitting 25 of the housing 21 in the end fitting housing 15 of the valve body 11.

For example, the height of the end fitting housing 15 can be of the order of 6 to 8 mm and the diameter of the end fitting housing 15 can be of the order of 7 to 9 mm, and the end fitting 25 of the casing 21 can have corresponding dimensions, i.e., of the order of 6 to 8 mm long and with a diameter of the order of 7 to 9 mm. Of course, other dimensions can be suitable.

In general, according to the invention, the end fitting 25 of the casing 21 therefore acts as a centring stud, the function of which is to ensure correct positioning of the cover 40/electronic device 20 assembly on the body 11 of the valve 10, and to do so easily and without screwing or the like, while the electronic device 20 is kept secured to the cover 40, and not to the valve body 11, by virtue of the cooperation between one or more shoulders 44 and one or more grooves 24.

The container according to the invention is particularly well suited to be used for storing a medical gas selected from among oxygen, an N₂O/O₂, NO/N₂ or He/O₂ gaseous mixture, or medical air, advantageously medical-grade oxygen.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. Pressurised fluid container (30), in particular a gas cylinder, comprising a container body (31) having an internal volume for holding a pressurised fluid and being equipped with a fluid dispensing valve (10) comprising:
a valve body (11) comprising an end fitting housing (15) opening outwards;
an electronic device (20) comprising a casing (21) comprising an end fitting (25) configured to be housed in the end fitting housing (15) of the valve body (10); and
a protective cover (40) arranged around the valve body (11), comprising an opening (42) comprising a peripheral edge (43) surrounding the casing (21) of the electronic device (20);
wherein at least part of the peripheral wall (21.1) of the casing (21) of the electronic device (20) is shaped so as to cooperate with at least part of the peripheral edge (43) of the opening (42) of the protective cover (40) in order to keep the electronic device (20) secured to the protective cover (40), when the end fitting (25) of the casing (21) is housed in the end fitting housing (15) of the valve body (11),
characterised in that the peripheral wall of the casing (21.1) of the electronic device (21) comprises at least one peripheral groove (24) and the peripheral edge (43) of the opening (42) of the protective cover (40) comprises at least one shoulder (44), or vice versa, with said shoulder (44) being inserted into said peripheral groove (24) in order to ensure that the electronic device (20) is secured to the protective cover (40).

2. Container according to claim 1, characterised in that the peripheral wall (21.1) of the casing (21) of the electronic device (20) and the peripheral edge (43) of the opening (42) of the protective cover (40) are shaped so as to have matching shapes enabling the electronic device (20) to be secured to the protective cover (40).

3. Container according to claim 1, characterised in that said at least one peripheral groove (24) is arranged on at least part of the outer perimeter of the peripheral wall (21.1) of the casing (21) of the electronic device (20) and/or said at least one shoulder (44) is arranged on at least part of the inner perimeter of the peripheral edge (43) of the opening (42) of the protective cover (40).

4. Container according to claim 1, characterised in that:
the end fitting (25) of the casing (21) assumes a first generally cylindrical shape and is devoid of external threading; and/or
the end fitting housing (15) of the valve body (11) assumes a second generally cylindrical shape and is devoid of an internal tapping.

5. Container according to claim 1, characterised in that the first generally cylindrical shape of the end fitting (25) of the casing (21) and the second generally cylindrical shape of the end fitting housing (15) of the valve body (11) match each other.

6. Container according to claim 1, characterised in that the peripheral wall (21.1) of the casing (21) of the electronic device (20) has a square or rectangular outer periphery, and the opening (42) of the protective cover (40) has a square or rectangular inner periphery, with the outer periphery of the housing (21) matching the inner periphery of the opening (42) of the cover (40).

7. Container according to claim 1, characterised in that the electronic device (20) is kept secured to the valve body (11), and the end fitting (25) of the casing (20) is kept housed in the end fitting housing (15) of the valve body (11), solely by virtue of the cooperation between at least part of the peripheral wall of the casing (21) of the electronic device (20) and at least part of the peripheral edge (43) of the opening (42) of the protective cover (40).

8. Container according to claim 1, characterised in that the casing (21) of the electronic device (20) comprises data processing means with at least one microprocessor.

9. Container according to claim 1, characterised in that the end fitting housing (15) of the valve body (11) has a closed base.

10. Container according to any of the preceding claims, characterized in that it contains a gas or a gaseous mixture in its internal volume that is selected from among oxygen, air or an Ar/O₂, N₂O/O₂, NO/N₂ or He/O₂ gaseous mixture.

11. Container according to claim 1, characterised in that the body (41) of the protective cover (40) is formed by at least two half-shells that are connected to each other.

12. Container according to claim 11, characterised in that the 2 half-shells are substantially symmetrical to each other.

13. Container according to any of claim 11 or 12, characterised in that the 2 half-shells are connected to each other along a junction plane separating the opening (42) of the cover (40) into two substantially equal parts.

14. Container according to any of claim 1 or 11, characterised in that the body (41) of the protective cover (40) is made of polymer material, of metal or of combinations thereof.

15. Use of a container (30) according to any of the preceding claims, for storing or supplying a pressurised gas, in particular a medical gas, selected from among oxygen, air or an Ar/O₂, N₂O/O₂, NO/N₂ or He/O₂ gaseous mixture.
